(19) United States
(12) Patent Application Publication
(10) Pub. No.: US 2024/0132741 A1
(43) Pub. Date: Apr. 25, 2024

(54) Biodegradable Shading Paint

(71) Applicant: Lumiforte Holding B.V., Baarle-Nassau (NL)

(72) Inventors: Mathieu Robert Andre Fiore, Villeurbanne (FR); Petrus Cornelis Gerardus Maria Van Oerle, Breda (NL); Elizabeth Antoinette Maria Van Hamersveld, Rijen (NL); Roel Henri Martinus Weijers, Eindhoven (NL)

(21) Appl. No.: 18/546,606

(22) PCT Filed: Feb. 18, 2022
(86) PCT No.: PCT/NL2022/050087

§ 371 Date: Aug. 15, 2023

(30) Foreign Application Priority Data
Feb. 18, 2021 (NL) 2027587

(51) Int. Cl. C09D 103/04; A01G 9/14; C09D 5/00; C09D 7/61; C09D 7/63; C09D 9/00

(52) U.S. Cl. CPC C09D 103/04; A01G 9/1438; C09D 5/008; C09D 7/61; C09D 7/63; C09D 9/00; C08K 2003/265

(57) ABSTRACT

The invention pertains to a biodegradable coating composition, comprising a crosslinked starch and a filler, and optionally a polyol plasticizer, as well as to outside structures such as greenhouses, comprising a coating layer obtained by drying the said coating composition. The invention furthermore pertains to removal of the coating layer using a targeted cleaning composition.

The invention is in the field of coating compositions for outside use, in particular shading paints for greenhouses.

### BACKGROUND

In horticulture, greenhouses are a major tool for adapting growth conditions of in particular plants. Using a greenhouse, the growth conditions of a plant can be optimized so as to safeguard the steady supply of for example plant-based foods. However, seasonal changes in weather affect outside temperature and light conditions, furthermore influenced by geographical location. Too much light or heat may negatively affect growth of crops.

To protect crops during spring and summer against excess light and heat, it is known to apply a shading paint. A shading paint is applied to a greenhouse in the form of an aqueous composition, which comprises some form of pigment as well as a binder. The binder is often a polymer, such as for example an acrylic polymer. After application and drying of the composition, a layer of the pigment embedded in the polymer binder is formed on the greenhouse, which layer provides shading. However, to accommodate for periods with less light and heat, it is preferred to apply a shading paint which either degrades, or can be removed actively.

In an autodegrading shading paint, the binder slowly degrades by the influence of UV-light and water, so that over the course of several months the pigment is washed away from the greenhouse. Thus, the layer of shading paint gradually provides less shading, until ultimately, there is barely any shading paint left on the greenhouse. Generally, the degradation rate of the shading paint has been tuned to the weather conditions so that the shading paint has more or less disappeared after summer, when shading is no longer necessary.

A second type of shading paint composition is an on/off shading paint, which may also be called a removable shading paint, or a shading paint which can be removed actively. This type of shading paint has been optimized to resist weather conditions as good as possible. At any time, the grower can decide to remove the shading paint to restore the regular transparency of the greenhouse windows. Removal is effected by a form of dedicated cleaner, such as an alkali-based cleaner.

Regardless of whether the shading paint is autodegrading or removable, the shading paint composition which disappears from the greenhouse ultimately ends up in the environment around the greenhouse. For an autodegrading shading paint, accumulation of the binder in the environment starts with the slow degradation of the binder, and rains rinse the binder into the soil and/or surface water around the greenhouse. For an on/off type of shading paint, the cleaner causes swift solubilization of the binder. Because the size of the greenhouse surface prevents collection of the removed paint, also in this case, the shading paint ends up in the soil and/or surface water around the greenhouse.

In WO 2018/169404, an alkali-removable biodegrading coating has been described, which comprises a polymeric polyester binder having a molecular weight of 2000-50000 g/mole with an acid value of 40-250 mg KOH/g polymeric binder, which is preferably not crosslinked. Although the binder is called “biodegradable”, it is in fact not fully biodegradable; the biodegradability is shown to be between 23 and 83% (OECD 301 F).

WO 99/22588 also describes an alkali-removable protective coating comprising a pigment and a polymeric binder, such as a vinyl or acrylate polymer. The binder has an acid value of 40-250 and a weight-average molecular weight of 10000-100000. There is no reference to biodegradability, and the synthetic polymer chains and segments after removal are not generally environmentally benign.

EP 2 361 957 describes an alkali-removable protective coating preparation comprising a binder and a pigment, wherein the binder is a polymer produced by anionic polymerization, in particular an acrylate or vinyl polymer, which has an acid value of 100-200 and an average molecular weight of 5000-10000. There is no reference to biodegradability, and the polymer chains after removal are not generally environmentally benign.

CN 101 914 336 and CN 102 676 006 both also describe aqueous polyacrylate coatings, for which there is no report on biodegradability, nor on the environmental impact of the polymer chain fragments after removal.

In these shading paints, the polymeric binder is a synthetic polymer, which pollutes the environment after removal of the shading paint at least to some extent. It is beneficial to obtain a shading paint composition which has no environmental impact. To achieve this, the shading paint composition must be fully biodegradable, and any remaining fragments of the shading paint must be environmentally benign. The present invention provides such a shading paint composition.

EP 2 370 503 describes biolatex conjugates for use in compositions for coating paper and cardboard, which provide superior whiteness and brightness. The biolatex conjugates are included into paper coating formulations which furthermore comprise styrene-butadiene latex (“SB latex”). SB latex is not biodegradable, as is generally known, and consequently, the coating compositions in this document are not biodegradable.

CN 105 368 164 describes biodegradable interior wall paint compositions which comprise vegetable starch. The interior wall paint compositions comprise borax as a crosslinking agent, which is CMR (carcinogenic, mutagenic and/or toxic to reproduction) in quantities above 0.3 wt. %. Thus, the compositions in this document are largely CMR, and therefore dangerous to apply on the outside of a structure such as a greenhouse.

### FIGURES

FIG. 1: Evolution of shading performance of autodegrading paint types in time (formula 1-4), as expressed by the average light transmission in the range of 400-800 nm in time.

FIG. 2: Evolution of shading performance of ON/OFF type paints in time (Formula 7-10), as expressed by the average light transmission in the range of 400-800 nm in time.

### DETAILED DESCRIPTION

The present invention provides a biodegradable coating composition, comprising a crosslinked starch and a filler, and optionally a polyol plasticizer, and a method for application and removal of the coating composition.

The present coating composition is intended for outside use, for example as a shading paint on a greenhouse. It is an advantage of the invention that by using a crosslinked starch as binder, the binder is fully biodegradable and environmentally benign, but at the same time provides sufficient weather resistance to allow for formulation both as an autodegrading coating composition and as an on/off coating composition. Weather resistance of the presently disclosed coatings is very similar to the weather resistance of coatings based on synthetic polymer binders, but provide the additional advantage of biodegradability and low environmental impact.

Biodegradable, in this context, is defined as biodegradability as determined using method OECD 301, as outlined in more detail in the examples. This method is a generally known method to evaluate biodegradability. Biodegradable is defined as a biodegradability of at least 90%, preferably at least 95%, as determined using the method OECD 301.

Environmentally benign, in this context, is understood to mean that the binder is not only fully biodegradable, but also lacks further hazardous environmental impact. Thus, the binder is not carcinogenic, mutagenic or toxic to reproduction (non-CMR).

The Crosslinked Starch

The coating composition comprises a crosslinked starch, which crosslinked starch functions as a binder. The crosslinked starch provides the required adhesion to form, after drying, a layer on a flat surface (such as a transparent panel of a greenhouse), said layer comprising the crosslinked starch and the filler. When used as a shading paint on a greenhouse, this layer provides shade to the greenhouse interior, resulting in light and/or heat reduction. When used as a shading paint on a non-transparent outside wall and/or roof, the layer provides heat reduction.

The crosslinked starch may be any type of starch, and may also be a mixture comprising two or more types of starch. The starch can be cereal starch (e.g. rice, wheat, and maize), root starch (e.g. potatoes and cassava) or bean starch (e.g. mung beans, peas, fava, lentil and chickpeas), but can also be from other sources (e.g. acorn, arrowroot, barley, breadfruit, millet, oat, sago, sorghum, sweet potato, rye, taro, chestnut, water chestnut and yam). Preferred starch types are cereal starch and root starch, in particular maize starch and potato starch.

Starch is isolated from plants as a granular substance, which granular substance comprises amylose and amylopectin. Both amylose and amylopectin are water soluble polymers of glucose; amylose is an essentially linear chain of hundreds to many thousands of glucose moieties, whereas amylopectin is a branched molecule, which may comprise up to a few hundred thousand glucose moieties. The ratio of amylose to amylopectin in a starch granule varies with the origin of the starch, and is generally known. In general, regular (“natural”) starch comprises 10-30 wt. % of amylose and 70-90 wt. % of amylopectin.

Also, plant varieties exist from which starch can be isolated which starch is enriched in amylose or amylopectin, relative to the “natural” ratio between amylose and amylopectin in a starch type. Starch types enriched in amylose are called “amylose-rich”, and starch types enriched in amylopectin are called “waxy”. Waxy starch is starch with an amylopectin content of at least 90 wt. %, preferably at least 95 wt. %, more preferably at least 98 wt. %. Amylose-rich starch is starch with an amylose-content of at least 30 wt. %, preferably at least 40 wt. %, more preferably at least 50 wt. %.

The crosslinked starch in the present context may be a regular starch, defined as a starch type with a “natural” ratio of amylose to amylopectin for the type of starch in question. However, the crosslinked starch may also be an amylose-rich starch or a “waxy” type of starch. In one preferred embodiment, the starch is a crosslinked waxy starch. In another preferred embodiment, the starch is a crosslinked regular starch.

The crosslinked starch is a starch which has been subjected to a crosslinking reaction, thereby introducing covalent bonds between different segments of the same or different glucose polymers. This leads to a network of starch molecules. Crosslinking has been found to increase weather resistance considerably, so that crosslinked starch has sufficient weather resistance to result in a usable coating.

The type of crosslinker is not particularly limiting, as long as at least some crosslinking of the starch has occurred, and as long as the crosslinking does not impart non-environmentally benign characteristics. The crosslinked starch is preferably non-CMR; furthermore the crosslinker is preferably non-CMR. Further preferably, the crosslinked starch is a non-borax crosslinked starch, and the crosslinker is preferably not borax.

The crosslinked starch is preferably a sodium trimetaphosphate crosslinked starch, an ammonium zirconium carbonate crosslinked starch, a copper crosslinked starch, a magnesium crosslinked starch, a borax crosslinked starch, a zirconium crosslinked starch, a titanium crosslinked starch (such as a titanium lactate, titanium malate, titanium citrate, titanium ammonium lactate, polyhydroxy complexes of titanium, titanium triethanolamine, or a titanium acetyl acetonate crosslinked starch), a calcium crosslinked starch, an aluminum crosslinked starch (such as an aluminum lactate or aluminum citrate crosslinked starch), a boron crosslinked starch, a chromium crosslinked starch, an iron crosslinked starch, an antimony crosslinked starch, a glyoxal crosslinked starch, a p-benzoquinone crosslinked starch, a polycarboxylate crosslinked starch (such as a citric acid, maleic acid, glutaric acid, succinic acid, phthalic acid and/or malic acid crosslinked starch), a phosphite crosslinked starch, a phosphate crosslinked starch, a silicate crosslinked starch (such as tetraethyl orthosilicate (TEOS), an epichlorohydrin crosslinked starch, a periodate crosslinked starch, a dialdehyde crosslinked starch or an anhydride crosslinked starch.

In preferred embodiments, the crosslinked starch is a sodium trimetaphosphate crosslinked starch, an ammonium zirconium carbonate crosslinked starch, a copper crosslinked starch, a magnesium crosslinked starch, a zirconium crosslinked starch, a titanium crosslinked starch (such as a titanium lactate, titanium malate, titanium citrate, titanium ammonium lactate, polyhydroxy complexes of titanium, titanium triethanolamine, or a titanium acetyl acetonate crosslinked starch), a calcium crosslinked starch, an aluminum crosslinked starch (such as an aluminum lactate or aluminum citrate crosslinked starch), a boron crosslinked starch, a chromium crosslinked starch, an iron crosslinked starch, an antimony crosslinked starch, a p-benzoquinone crosslinked starch, a polycarboxylate crosslinked starch (such as a citric acid, maleic acid, glutaric acid, succinic acid, phthalic acid and/or malic acid crosslinked starch), a phosphite crosslinked starch, a phosphate crosslinked starch, a silicate crosslinked starch (such as tetraethyl orthosilicate (TEOS), or a periodate crosslinked starch.

Most preferably, the crosslinked starch is a sodium trimetaphosphate (STMP) crosslinked starch or an ammonium zirconium carbonate (AZC) crosslinked starch.

The crosslinked starch preferably has a ratio of crosslinking, defined as a wt. % of crosslinker relative to the weight of the starch which has been crosslinked, of 1-50%, preferably 3-25%, more preferably 5-15%. A much preferred ratio of crosslinking is 3-50%, preferably 5-50%. The ratio of crosslinking expresses the degree of crosslinking of the starch, and directly impacts weather resistance: a higher degree of crosslinking provides for a higher weather resistance.

The skilled person appreciates that the ratio of crosslinking is expressed on the basis of the quantities of the starting materials prior to the crosslinking reaction, and that in order to obtain the crosslinked starch, the starch and the crosslinker must also be subjected to reaction conditions (solvent, temperature and the like) and work-up which are appropriate for the type of crosslinker in question. For the applicable types of crosslinker, appropriate reaction conditions and purification methods to obtain crosslinked starch are generally known.

In a preferred embodiment, the crosslinked starch is a gelatinized crosslinked starch. In the present context, a gelatinized crosslinked starch in an aqueous coating composition provides a dissolved but covalently bonded network of starch molecules. After application to for example a greenhouse and subsequent drying, this provides a binder with sufficient adhesion and weather resistance.

Gelatinization of starch is generally known to mean the process in which starch granules in an aqueous environment dissolve, so as to result in a solution of (individually solubilized) amylose- and amylopectin molecules.

Starch gelatinization generally requires high energy, such as high temperature and/or pressure.

In a much preferred embodiment, the crosslinked starch is a pregelatinized crosslinked starch. A pregelatinized starch is a starch which has been subjected to gelatinization, but which is subsequently dried, for example by spray- or flash drying, or by other methods known in the art, to obtain the pregelatinized starch. A pregelatinized starch has the advantage that it can be readily dissolved in water.

The crosslinked starch in the coating composition is preferably gelatinized. In much preferred embodiments, the crosslinked starch is a pregelatinized starch which is subsequently crosslinked, to result in a pregelatinized crosslinked starch.

In a further preferred embodiment, the crosslinked starch is a partially hydrolyzed crosslinked starch (a “crosslinked starch hydrolysate”), such as by acid hydrolysis or enzymatic degradation, which is further preferably additionally pregelatinized. Starch hydrolysis results in a shorter chain length, as is generally known. In the present coating composition, application of a partially hydrolyzed starch has the advantage of viscosity reduction, which facilitates starch incorporation in the coating composition, and renders application of the coating composition to for example a greenhouse easier.

A hydrolyzed starch, in this context, is defined by the DE (“dextrose equivalent”) value, as is known in the art. The DE expresses the extent to which the starch has been hydrolyzed. The DE of pure glucose is 100, the DE of pure maltose is 50, and the DE of starch is very close to 0. A partially hydrolyzed starch, in this context, is a starch having a DE of 0.1-15, preferably 0.1-10, more preferably 0.5-10, or 1-10.

In general, the partially hydrolyzed crosslinked starch is a crosslinked starch which has a DE of 0.1-15, preferably 0.1-10, more preferably 0.5-10, or 1-10.

The crosslinked starch may have been subjected to further starch modification. For example the crosslinked starch may be additionally stabilized, such as by etherification or esterification. A crosslinked starch of the invention may thus also be hydroxyethylated, hydroxypropylated or succinilated, for example. Furthermore, the crosslinked starch may have also been oxidized, such as by chlorite oxidation. Also, the crosslinked starch may have been thermally inhibited.

The Filler

The biodegradable coating composition furthermore comprises a filler. A filler in this regard may also be called a pigment. The filler can for example be an inorganic pigment, such as for example calcium carbonate, titanium oxide, boehmite, mica, silicate (such as magnesium or aluminum silicate), gypsum, baryte, aluminum oxide, magnesium oxide, talc, clay, an interference pigment, or any combination thereof.

For the purpose of shading a greenhouse or another outside structure, the skilled person appreciates that different types of filler may be applied for different purposes, and in different concentrations. For example, titanium oxide has high reflection, so that a relatively minor quantity is needed for shading and heat reduction. Calcium carbonate requires more filler to effect similar shading, but is cheaper and has the additional advantage of becoming slightly translucent when wet. This allows for adapting the light intensity inside a greenhouse to the weather conditions. Boehmite is known to result in high light scattering, which is favorable for shading a greenhouse with a diffuse coating, usable for a crop which requires a uniform high light intensity.

The type of filler to be used in the present invention is not particularly limited. The weight ratio of filler:crosslinked starch is preferably in the range of 0.05-50, preferably 0.1-40, more preferably 0.5-30, more preferably 1-28.

The Polyol Plasticizer

In much preferred embodiments, the biodegradable coating composition comprises a polyol plasticizer. The plasticizer has the effect of reducing brittleness of the coating layer, which increases weather resistance even further.

The polyol plasticizer can be any known plasticizer which comprises two or more groups capable of hydrogen bonding, preferably hydroxy groups. Preferably, the polyol plasticizer is sorbitol, glycerol, ethylene glycol, polyethylene glycol, xylitol, glucose, fructose, galactose, mannitol, sucrose, maltitol, urea, or any mixture thereof, most preferably sorbitol, glycerol or ethylene glycol.

The weight ratio of crosslinked starch to polyol plasticizer, if present, is preferably in the range of 0.2-10, preferably 0.3-8, more preferably 0.4-6.

The Coating Composition

The biodegradable coating composition can be a dry coating composition or an aqueous coating composition. A dry coating composition is preferably a free flowing powder, which has the advantage that the weight of the composition is minimized.

Preferably however, a coating composition of the invention is an aqueous coating composition. An aqueous coating composition of the invention preferably comprises a crosslinked starch as defined elsewhere, a filler and water. This has the advantage that homogenization of the coating can be performed in a controlled environment at large scale.

Further preferably, the aqueous coating composition is a concentrated coating composition, which can be diluted at the site of application. This has the advantage that transport weight is minimized, while still allowing for homogenization in a controlled environment at a large scale.

A concentrated aqueous coating composition of the invention preferably has a dry solids content of 10-90 wt. %, based on the total weight of the composition, more preferably 25-70 wt. %, more preferably 40-70 wt. %.

The concentrated aqueous coating composition is preferably diluted with water prior to application, such as by 1-20 parts by weight of water, relative to the total weight of the concentrated aqueous coating composition, more preferably 1-15 parts by weight, more preferably 1-10 parts by weight, more preferably 2-8 parts by weight, most preferably 3-6 parts by weight.

This dilution results in a dry solids content in the aqueous coating composition as it is to be applied of preferably 1-50 wt. %, relative to the total weight of the coating composition, preferably 3-35 wt. %, more preferably 5-20 wt. %.

Thus, an aqueous coating composition of the invention can have a dry solids content of 1-90 wt. %, based on the total weight of the composition, preferably 3-70 wt. %, more preferably 5-65 wt. %.

In preferred embodiments, the coating composition comprises, as wt. % of the dry weight of the composition, 1-50 wt. %, preferably 1.5-30 wt. %, more preferably 2.0-20 wt. % of crosslinked starch.

Furthermore, the coating composition preferably comprises, as wt. % of the dry weight of the composition, a quantity of filler of 1-97 wt. %, preferably 50-95 wt. %, more preferably 75-94 wt. %.

Also, the coating composition may optionally comprise, as wt. % of the dry weight of the composition, a quantity of polyol plasticizer of 0.05-20.0 wt. %, preferably 0.5-15 wt. %, more preferably 1.0-7.0 wt. %.

In addition, the coating composition preferably comprises at least one selected from the group consisting of a dispersing agent, a wetting agent, a leveling agent, an adhesion promoter, a biocide, an antifoam agent, a coalescing agent, a thickener, a pH modifier and an antifreeze agent.

The dispersing agent can for example be a phosphate, acrylic acid, sulphonate or a gluconate.

A dispersing agent, if present, may be comprised in the composition in a quantity of 0.05-2.5 wt. %, relative to the dry weight of the composition.

The wetting agent can for example be a polyurea or a polyether.

A wetting agent, if present, may be comprised in the composition in a quantity of 0.05-2.5 wt. %, preferably 0.1-1.5 wt. %, based on the dry weight of the composition.

The leveling agent can for example be a non-ionic surfactant comprising fluorine or silicone, or a sulfoccinate.

A leveling agent, if present, may be comprised in the composition in a quantity of 0.05-1.0 wt. %, based on the dry weight of the composition.

The adhesion promoter can for example be a silane-based compound with amines or epoxy functionality, such as γ-aminopropyltriethoxysilane, γ-aminopropyltrimethoxy silane, γ-(methylamino)propyltrimethoxy silane, γ-aminopropylmethyldiethoxy silane, Y-(2-aminoethyl-3-aminopropyl)triethoxy silane and Y-(2-aminoethyl-3-aminopropyl)methyldimethoxy silanes, or a metal-based adhesion promotor.

An adhesion promotor, if present, may be comprised in the composition in a quantity of 0.05-4.0 wt. %, preferably 0.1-1 wt. %, based on the dry weight of the composition.

The biocide can for example be 1,2-benzisothiazol-3(2H)-one (BIT), 2-methyl-2H-isothiazol-3-one (MIT), 5-chloro-2-methyl-2H-isothiazol-3-one (CMIT), bromopol, sodium pyrithione or zinc pyrithione.

A biocide, if present, may be comprised in the composition in a quantity of 0.001-1.0 wt. %, preferably 0.002-0.5%, based on the dry weight of the composition.

The antifoam agent can for example be a non-ionic surfactant, such as a liquid hydrocarbon, a natural oil, a hydrophobic silica, or a silicone.

An antifoam agent, if present, may be comprised in the composition in a quantity of 0.1-2.0 wt. %, preferably 0.25-1 wt. %, based on the dry weight of the composition.

The coalescing agent can for example be solvent capable of dissolving the crosslinked starch, for example texanol (isobutiric acid), citrofol, an oleochemical glycol ether, methoxy propylene, acetyltributyl citrate, or a hexanoate.

A coalescing agent, if present, may be comprised in the composition in a quantity of 0.05-5.0 wt. %, preferably 0.1-1.0 wt. %, based on the dry weight of the composition.

The thickener can for example be a xanthan gum, a cellulose or a cellulose derivative such as hydroxyethyl cellulose (HEC) or microfibrillated cellulose (MFC), a polyurethane-based thickener, an acrylic copolymer, a clay, or a non-crosslinked starch-based thickener.

A thickener, if present, may be comprised in the composition in a quantity of 0.05-5.0 wt. %, preferably 0.08-1.5 wt. %, based on the dry weight of the composition.

The pH modifier can for example be a common acid or base, as is generally known in the art, including strong and weak bases and strong or weak acids. (Non-limiting) examples are sodium or potassium hydroxide, sodium bicarbonate, ammonia, hydrochloric acid, sulphuric acid, citric acid, and gluconic acid.

A pH modifier, if present, may be comprised in the composition in a quantity effective to reach the desired pH, as is known in the art. The quantity of pH modifier is preferably chosen so as to attain a final pH of the coating composition of 4-12, preferably 5-11, more preferably 6-10.

The quantity of pH modifier is preferably in the range of 0.05 to 10.0 wt. %, based on the dry weight of the composition.

The antifreeze agent can for example be urea or glycol.

An antifreeze agent, if present, may be comprised in the composition in a quantity of 0.05 to 5.0 wt. %, based on the dry weight of the composition.

The coating composition of the invention can be prepared by dispersion of the different raw materials in a vessel under agitation. In preferred embodiments, solid raw materials are dispersed into water, to prepare an aqueous coating composition, as defined elsewhere.

Preferably, agitation during dispersion is adjusted so as to attain a desired particle size of the filler. A desired filler particle size is for example a particle size of at most 100 μm, preferably at most 70 μm. Particle size may for example be measured by a Malvern particle size analyzer, as is generally known in the art.

Thus, the invention furthermore provides a method for preparing a biodegradable coating composition comprising a crosslinked starch and a filler, and optionally a polyol plasticizer, as defined elsewhere, comprising dispersion of the crosslinked starch and the filler, and optionally the polyol plasticizer, in water. Preferably, the dispersion is achieved by homogenization in a suitable vessel, such as a bucket or a closable vessel, by methods for homogenization generally known in the art. In much preferred embodiments, homogenization is achieved by first homogenizing under high stress until the desired particle size of the filler is attained, and subsequently further mixing.

A coating composition of the invention can be formulated as an on/off type coating composition, or as an autodegrading type coating composition; these types can be distinguished primarily by their rate of degradation under the conditions where it is to be applied.

The quantity of filler and the quantity of crosslinked starch primarily determine whether a formulation is an on/off type composition or an autodegrading type composition; however, the optional further ingredients of the formulation also influence the degradation of the coating. The degradation of the coating is furthermore influenced by external conditions such as weather. For this reason, a “hard” distinction between an on/off type coating and an autodegrading type coating cannot be made.

The skilled person appreciates that some overlap exists between the two types of coating compositions: coating compositions with higher degradation rate under the weather conditions where it is applied may more readily be considered an autodegrading type coating composition; conversely, coating compositions with a higher resistance to degradation may be considered an on/off type coating composition. Based on the below formulation examples and the common general knowledge on the degradation rate of a specific coating formulation, and some exemplary routine experiments, the skilled person can determine whether a specific coating formulation can be considered an on/off type coating composition, an autodegrading type coating composition, or, in boundary cases, whether the assignment of either type is to be considered ambiguous.

The Autodegrading Shading Paint

In case a coating composition of the invention is formulated as an autodegrading shading paint, the coating composition comprises a quantity of crosslinked starch that is lower than 10 wt. %, preferably lower than 7.2 wt. %, preferably lower than 5 wt. %, preferably lower than 4 wt. % but higher than 1 wt. %, relative to the dry weight of the composition, most preferably 1.5-7.2 wt. %. Such compositions have the advantage that they do not need to be actively removed. They can be formulated so as to remain intact for a period of multiple weeks or months, also in view of the average weather conditions on site.

A concentrated autodegrading shading paint preferably comprises, as wt. % of the total composition:
water 35-55 wt %, preferably 40-50 wt. %; and
filler 35-65 wt. %, preferably 40-60 wt. %, more preferably 45-55 wt. %; and
crosslinked starch 0.5-7.0 wt. %, preferably 1-6 wt. %, more preferably 1.5-5 wt. %
and further preferably comprises, as wt. % non-aqueous material in the total composition
antifoam 0.05-0.8 wt. %, preferably 0.1-0.5 wt. %; and/or
thickener 0.01-0.8 wt. %, preferably 0.05-0.4 wt. %; and/or
wetting agent 0.1-1 wt. %, preferably 0.2-0.8 wt. %; and/or
biocide 0.001-1.0 wt. %, preferably 0.005-0.5 wt. %; and/or
plasticizer 0.1-5.0 wt. %, preferably 0.5-3.0 wt. %; and/or
coalescing agent 0.05-0.8 wt. %, preferably 0.1-0.6 wt. %; and/or
adhesion promotor 0.02-0.5 wt. %, preferably 0.05-0.25 wt. %.

In much preferred embodiments, a concentrated autodegrading shading paint comprises all of the above in combination.

The concentrated autodegrading shading paint is preferably applied in a diluted form, such as in a dilution of 1 mass equivalent of the concentrated composition with 1-10 mass equivalents of water, more preferably 1 mass equivalent of the concentrated composition with 2-5 mass equivalents of water.

The on/Off Shading Paint

In case a coating composition of the invention is formulated as an on/off shading paint, the quantity of crosslinked starch in the composition is preferably 2-30 wt. % wt. %, more preferably 5-25 wt. %, more preferably 6-20 wt. %, relative to the dry weight of the composition. Such compositions have the advantage that they remain intact for periods of many months, such as 2-9 months, preferably 3-6 months. Such compositions have the further advantage that they may be removed at any time by active cleaning with an appropriate cleaner.

A concentrated on/off shading paint preferably comprises, as wt. % of the total composition:
water 25-60 wt. %, preferably 30-55 wt. %; and
filler 35-64 wt. %, preferably 40-60 wt. %, more preferably 45-55 wt. %; and
crosslinked starch 2-20 wt. %, preferably 3-18 wt. %, more preferably 4-15 wt. %;
and further preferably comprises
antifoam 0.05-0.8 wt. %, preferably 0.1-0.5 wt. %; and/or
thickener 0.01-0.8 wt. %, preferably 0.05-0.4 wt. %; and/or
wetting agent 0.1-1 wt. %, preferably 0.2-0.8 wt. %; and/or
biocide 0.001-1.0 wt. %, preferably 0.005-0.5 wt. %; and/or
plasticizer 0.1-5.0 wt. %, preferably 0.5-3 0.0 wt. %; and/or
coalescing agent 0.05-0.8 wt. %, preferably 0.1-0.6 wt. %; and/or
adhesion promotor 0.02-0.5 wt. %, preferably 0.05-0.25 wt. %.

In much preferred embodiments, a concentrated on/off shading paint comprises all of the above in combination.

The concentrated ON/OFF shading paint is preferably applied in a diluted form, such as in a dilution of 1 mass equivalent of the concentrated composition with 1-10 mass equivalents of water, more preferably 1 mass equivalent of the concentrated composition with 2-5 mass equivalents of water.

Removal of the Coating

It is a distinct advantage of the invention that the biodegradable coating composition can be removed at any time by treatment with a cleaning composition. Although a cleaning composition is generally intended to remove on/off type coating compositions, the skilled person appreciates that also autodegrading coating compositions may be removed in the same manner as an on/off type coating composition.

Coating compositions of the prior art were generally removed by an alkali cleaning composition, which has high pH of about 12-14. The present coating composition has the advantage that it can be removed with an environmentally benign aqueous cleaning composition, comprising a starch-degrading enzyme, and further optionally comprising a buffer, a viscosifier, a sequestrant and/or a surfactant.

The skilled person is aware which enzymes can be considered a starch-degrading enzyme. It can be tested whether an enzyme can be considered a starch degrading enzyme by subjecting a quantity of dissolved starch to the enzyme in question, under reaction conditions appropriate for the said enzyme. If starch is degraded (which can be ascertained by commonly known methods), the enzyme in question can be considered a starch degrading enzyme.

Preferably, the starch degrading enzyme comprises alpha-amylase [EC 3.2.1.1] or beta-amylase [EC 3.2.1.2]. The starch-degrading enzyme may be introduced by incorporation of one or more bacteria (“probiotics”) in the cleaning composition, which probiotics release at least one starch degrading enzyme.

The starch degrading enzyme is preferably present in the aqueous cleaning composition in a quantity of 0.001-1.0 wt. %, in dry mass relative to the total composition, preferably 0.01-0.5 wt. %, more preferably 0.05-0.3 wt. %.

The cleaning composition preferably further comprises a pH modifier. Suitable pH modifiers for stabilizing an enzyme solution at an appropriate pH for the type of enzyme are generally known, and comprise in general at least one weak acid and the conjugate base of said weak acid, or a weak base and the conjugate acid of said weak base. Alternatively, a strong acid or a strong base may be used in order to set the pH in a certain range. Suitable acids and bases (and their conjugate acids/bases) are well known in the art, and may include, for example citric acid, formic acid, gluconic acid, fluoric acid, hydrochloric acid, ammonia, carbonate and bicarbonate.

A pH modifier, if present, may be comprised in the composition in a quantity of 0.05 to 10 wt. %, preferably 0.1-7.5 wt. %, more preferably 0.2-5.0 wt. %, in dry mass relative to the total weight of the composition. The pH modifier may set the pH of the cleaning composition to 2-14, preferably 3-9.

The cleaning composition preferably further comprises a viscosifier. The viscosifier can for example be a xanthan gum, a cellulose or a cellulose derivative such as hydroxyethyl cellulose (HEC) or microfibrillated cellulose (MFC), a polyurethane-based thickener, a clay, or a hydrophobic silica.

A viscosifier, if present, may be comprised in the cleaning composition in a quantity of 0.05-5 wt. %, in dry mass relative to the total composition.

The cleaning composition preferably further comprises a sequestrant. The sequestrant can for example be ethylenediamine tetraacetic acid (EDTA), sodium citrate, gluconic acid or N,N-dicarboxymethyl glutamic acid tetrasodium salt (GLDA).

A sequestrant, if present, may be comprised in the cleaning composition in a quantity of 1-20 wt. %, in dry mass relative to the total weight of the composition, preferably 5-15 wt. %.

The cleaning composition preferably further comprises a surfactant. The surfactant can for example be a silicone, a phosphate a sulfoccinate or a non-ionic surfactant, such as a fatty alcohol comprising ethoxy or propoxy groups. A surfactant, if present, may be comprised in the cleaning composition in a quantity of 0.1-20 wt. %, preferably 0.5-15 wt. %, more preferably 0.5-5 wt. %, in dry mass relative to the total weight of the composition.

The cleaning composition further preferably may comprise 0.001-1 wt. % of a known antifoaming agent.

In much preferred embodiments, the cleaning composition comprises all of the above in combination.

The cleaning composition can be obtained by dispersion of the raw ingredients into water, and appropriate mixing.

Outside Structures Comprising the Coating Composition

The invention furthermore provides an outside structure at least partially provided with a biodegradable coating composition as defined elsewhere. An outside structure, in this regard, is a man-made structure in which human activities are carried out, such as a house, an office, an industrial building, or an agricultural building such as a greenhouse. In preferred embodiments, the coating composition is applied on the exterior surface of the outside structure. In further preferred embodiments, at least the roof section of the outside structure is essentially covered with the biodegradable coating composition. This provides for modulation of the interior climate of the outside structure, in particular heat reduction.

In preferred embodiments, the outside structure comprises one or more transparent panels. In much preferred embodiments, the one or more transparent panels are located in a roof section of the outside structure. In much preferred embodiments, the outside structure is an industrial building or a greenhouse, most preferably a greenhouse. If the coating of the invention is applied to one or more transparent panels comprised in the outside structure, preferably in a roof section thereof, the internal climate is additionally modulated by light reduction.

The outside structure can be any structure the interior of which requires heat reduction and/or shading. In preferred embodiments, the coating composition is applied on the exterior surface of the outside structure, in particular the exterior surface of an industrial building or a greenhouse, most preferably a greenhouse.

Thus, by applying a coating of the invention, the temperature inside an outside structure can be reduced whether or not the outside structure comprises transparent panels. Application of a coating of the invention to an essentially non-transparent section of an outside structure thus provides heat reduction.

In addition, light intensity can be reduced by applying the coating at least partially and preferably essentially completely to one or more transparent panels comprised in the outside structure, most preferably located in (at least) a roof section of the outside structure. This achieves not only light reduction, but also further temperature reduction, collectively referred to as “shading”.

A transparent panel comprised in the outside structure can be any type of transparent panel. Preferably, the transparent panel is a glass panel, a polycarbonate panel, a polyvinylidene fluoride (PVDF) panel, a polyacrylic panel, a polyvinyl chloride (PVC) panel or a polyethylene panel.

The invention as regards methods for modulating the internal climate of an outside structure will be discussed in the below on the exemplary basis of the outside structure being a greenhouse. However, the invention is not limited to application on a greenhouse; any outside structure can be provided with the present biodegradable coating composition in order to achieve light and/or heat reduction in its interior, and may thus benefit from the advantages attained with the present invention.

The invention furthermore provides a method for modulating the internal climate of an outside structure, preferably a greenhouse or an industrial building, most preferably a greenhouse, comprising a) providing the outside structure at least partially with an aqueous biodegradable coating composition as defined elsewhere, and b) drying the aqueous biodegradable coating composition to obtain a biodegradable coating layer. The coating is preferably applied on the exterior surface of the outside structure.

In preferred embodiments, the outside structure comprises one or more transparent panels. In further preferred embodiments, at least the one or more transparent panels are at least partially, and preferably essentially fully, provided with the aqueous biodegradable coating composition.

The internal climate of e.g. a greenhouse can be modulated by increasing or decreasing shade. The present biodegradable coating composition, after application and drying, increases shade in the interior of a greenhouse. Increased shade has the effect of decreasing light intensity in the greenhouse interior, which may be beneficial for the growth of particular crops, in particular in late spring or summer. Increased shade furthermore decreases the temperature in the greenhouse interior, which is also often favorable in late spring or summer.

Active or passive removal of the coating of the invention increases panel transparency and thus increases the light intensity in the exemplary greenhouse. At the same time, removal has the effect of raising the interior temperature. This can for example be favorable in late summer or autumn, when certain crops may benefit from enhanced light conditions, and no longer need increased shading.

Providing the outside structure, and/or transparent panels comprised in the outside structure with the aqueous coating composition can be done by any means. Preferably, the aqueous coating composition is applied by spraying or brushing the coating composition onto the outside structure, including any transparent panels comprised therein. This can be done manually, but may also be done using professional equipment, such as professional spraying equipment, among which a tank provided with a spraying hose and nozzle mounted on an individual's back, on a helicopter or a drone. After application of the aqueous coating composition, an aqueous layer forms on the surface of the transparent panel. Subsequent drying results in the formation of a dry coating layer, which dry coating layer provides shading.

The transparent panels of the exemplary greenhouse, or any non-transparent sections of the outside structure, need not be fully covered with the biodegradable coating composition. In some embodiments, part of a transparent panel or a non-transparent section can be left uncovered, so as to modulate the heat and light conditions further. In other embodiments, in situations where the greenhouse comprises multiple transparent panels, some of the panels may be fully covered, whereas other transparent panels are left fully uncovered. This, also, results in modulating of the interior climate of the greenhouse.

In preferred embodiments however, at least all the transparent panels of the exemplary greenhouse roof are substantially fully covered with the coating composition, thereby maximizing shade in the greenhouse interior. In further preferred embodiments, all transparent panels of the exemplary greenhouse are substantially fully covered with the coating composition. In case of application of the coating to non-transparent sections of the outside structure, partial or full covering is equally possible, with the similar aim of heat reduction.

Drying the biodegradable coating composition need not be an active step. Drying the coating composition is preferably achieved by allowing the weather to result in drying. However, in some embodiments the drying step may be accelerated, for example by air blowing or by application of heat.

The coating composition applied to a transparent panel or elsewhere and subsequently dried may also be referred to as a dried coating layer, or simply as the coating layer. The coating layer comprises a crosslinked starch and a filler, as well as other optional components, in the same relative quantities as the aqueous coating composition defined elsewhere.

Both an autodegracling type of coating composition and an on/off type coating composition may be removed by contacting the surface of the outside structure which is provided with the dried coating layer, with a cleaning composition as defined elsewhere. Said contacting may be achieved by any conceivable means, preferably spraying or brushing, either manually or by use of professional equipment, as defined elsewhere.

Upon contacting the coating layer with the cleaning composition, the biodegradable coating layer, in particular the crosslinked starch comprised therein, is degraded. This degradation results in an at least partially degraded coating composition, comprising amylose and/or amylopectin fragments.

Rinsing of the outside structure allows for removal of the at least partially degraded coating composition. This results in an increased interior temperature, and also in increased light intensity in cases where the coating was applied to one or more transparent panels. Rinsing may be achieved by a water hose, or by spraying water. Preferably however, rinsing is achieved by allowing rain to rinse the outside structure.

Said rinsing results in the amylose and/or amylopectin fragments to be dislocated to the soil and/or surface water around the outside structure. Amylose and amylopectin, as well as fragments thereof, are environmentally benign, and can be further degraded in the soil by microorganisms. The same is true for the other components of the cleaning composition.

Therefore, the present coating as well as its removal are environmentally benign, and biodegradable.

Thus, the invention furthermore provides a method for removal of a biodegradable coating layer comprising a crosslinked starch and a filler as defined elsewhere from an outside structure, preferably a transparent panel located in said outside structure, comprising contacting said biodegradable coating composition on the outside structure with a cleaner comprising a starch-degrading enzyme as defined elsewhere, and rinsing the outside structure.

In much preferred embodiments, the biodegradable coating composition which is removed from an outside structure such as a greenhouse is a coating composition which has been formulated as an on/off type coating composition, comprising 2-30 wt. % wt. %, preferably 5-25 wt. %, more preferably 6-20 wt. %, based on dry weight, of crosslinked starch.

For the purpose of clarity and a concise description features are described herein as part of the same or separate embodiments, however, it will be appreciated that the scope of the invention may include embodiments having combinations of all or some of the features described.

The invention will now be illustrated with the following non-limiting examples.

### EXAMPLES

Biodegradability

Biodegradability is evaluated using the standardized method OECD 301. In these examples, the version OECD 301A and/or OECD 301F is applied, which provide equivalent results as regards biodegradability; only the method to detect COD is different.

Briefly, the biodegradability is analyzed as follows. A more detailed method description is available from OECD:

A suspension of the tested composition in water at 15 mg/L solids content is inoculated with microorganisms and incubated under aerobic conditions in the dark, in duplo. Blanks (also in duplo) with the same quantity of inoculum but without test composition are run in parallel, as well as a reference compound (15 mg/L sodium acetate) with the same quantity of inoculum. An assay containing the tested composition and the reference substance at the tested concentrations is also run in order to verify degree of inhibition. All assays are kept at 22° C. throughout, under gentle stirring, and are run for 28 days.

The COD (chemical oxygen demand) is measured at the beginning and at the end of the assay, with further COD measurements being taken at days 1, 4, 7, 11, 14, 17, 21 and 25. The test expresses the biodegradability of the tested composition as a %, with 100% biodegradability being the optimal result.

As the filler is generally an inorganic mineral, it is not “biodegradable” as such, but also does not contribute to the environmental impact of the present coating composition. The same is true for the water in an aqueous composition. “Biodegradability” of the present coating composition thus is essentially determined on the basis of the binder (crosslinked starch), being the main organic constituent of the coating composition.

Weather Resistance (Wear Resistance)

To evaluate the weather resistance of the coating layer the following protocol is followed:

The coating composition is applied to two types of transparent panels: a standard glass panel of 4 mm thickness (no specific treatment) or a 200 μm PVC panel (5 Star Office, without a specific treatment). Comparable results are obtained with the two types of panels; the shown results are for glass panels.

Weather resistance of the coating layer is analyzed on the basis of a coating as it is to be applied in practice. The concentrated coating as it is prepared and distributed (recipes below) is diluted with water, using 25 wt. % of the concentrated coating and 75 wt. % of water.

Application of the coating layer is made by spraying the coating with a pneumatic system blowing air at 2 bars, through a specific nozzle resulting in a ray of small droplets. The coating is applied to the panel at a temperature of 22 (±2) ° C. and at a relative humidity between 40-60%. To replicate the degree of inclination of greenhouses, the panels (glass or plastic panels) are tilted at an angle of 30° during application of the diluted coating composition.

The coating layer is dried at ambient temperature, without using an air-blowing system or a heat system. Once the coating layer is dried, the evaluation of the weather resistance of the coating layer can be made. Coated panels are placed outside and naturally aged by rain and UV-light from the sun, under summer conditions, and analyzed repeatedly for the following parameters:
1. To visually evaluate the degradation of the coating a picture of the coating layer is taken in a Light Cabin using a normative Light Source (D65).
2. Light transmission measurements of the coating layer are performed using a UV-visible spectrophotometer (JASCO UV-Visible or JAZ20C from OCEAN OPTICS; these provide equivalent results). Light transmission in the range of 400-800 nm is averaged to provide a single value for the light transmission, which allows to quantify the amount of light shaded by the coating layer.

Between each measurement (Picture and Light transmission measurement) the coating is exposed to outside weather circumstances. The coating layer is put on a support outside, tilted at 30°, to reproduce greenhouses inclination. Because external conditions are always different (temperature, rain, wind, etc.) the test is done running a reference coating layer with known performance in parallel.

Cleaning Performance

ON/OFF coating layers (and, if needed, also autodegracling coating compositions) can be removed with an adequate cleaner composition.

Tests of the cleaning composition were performed using an ON/OFF coating layer which had been placed in outside weather conditions for 15 weeks. The coating composition was applied and dried as described above.

Application of the cleaning composition is done in the same way as application of the coating composition. The cleaning composition was applied at a 1:6 dilution by weight, relative to the concentrated cleaning compositions, the recipes of which are provided below. The cleaning composition was left on the coated surface, and allowed to dry as dictated by the weather conditions.

The cleaning composition, in particular the enzymes comprised therein, degrade the binder structure resulting in loss of adhesion to the substrate. Other components of the cleaning composition allow a removal of the filler present in the coating layer.

The cleaner and coating layer are rinsed by successive rains. Mechanical action of rain dissolves the mixture of cleaning composition and coating layer.

Visual inspection of the coating layer is made after rinsing. The cleaning performance is defined as optimum when no residues are left on the substrate. The cleaning performance is defined as medium when the binder is removed but some filler is still present on the substrate.

The cleaning performance is defined as low when the coating is still present on the substrate after rinsing.

Auto-Degrading Shading Paints:

The table represents different autodegrading formulas (as concentrated solution). In formula 1 to 3, varying quantities of TACKIDEX 1231 (from ROQUETTE) were used. This pregelatinized potato starch is already crosslinked by the supplier using phosphate based crosslinker. In formula 4, TACKIDEX 036SP (from ROQUETTE) was used. This pregelatinized potato starch is not crosslinked by the supplier. In Formula 5, TACKIDEX N735 was used, a non-crosslinked pea starch. Formula 6 was prepared without starch.

The different raw materials described in the below table were homogenized in a suitable vessel. Agitation speed was increased to more than 800 RPM before addition of the filler and lowered to below 600 RPM when a sufficient dispersion of the powder was obtained.

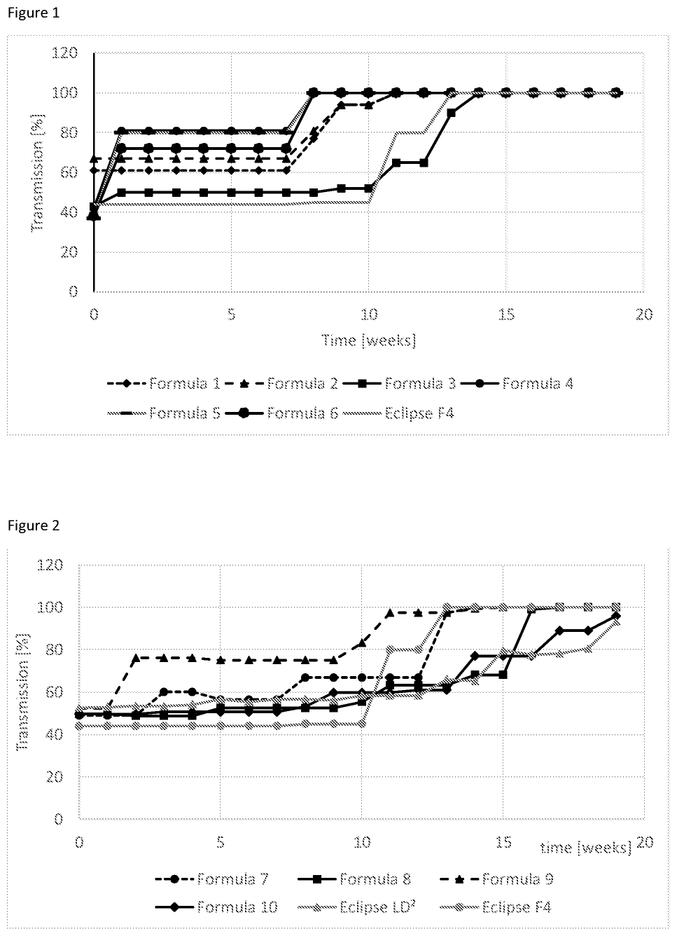

The wear resistance of the different formulas is shown in FIG. 1, in comparison to the commercial autodegrading paint Eclipse F4. Formula 3 is comparable with Eclipse F4 in term of wear resistance; Formula 3 even has higher wear resistance after 12 weeks. Formulas 1 and 2 are also suitable as shading paint.

The coating layer of coatings 1-3 is similar to the reference through the weeks based on visual inspection.

| All values in | Formula | Formula | Formula | Formula | Formula | Formula |
|---|---|---|---|---|---|---|
| wt. % | 1 | 2 | 3 | 4 | 5 | 6 |
| Water | 30.9 | 27.8 | 27.7 | 21.55 | 27.7 | 32.9 |
| Antifoam | 0.3 | 0.3 | 0.3 | 0.3 | 0.3 | 0.3 |
| Thickener | 0.1 | 0.1 | 0.1 | 0.1 | 0.1 | 0.1 |
| Wetting agent | 0.4 | 0.4 | 0.4 | 0.4 | 0.4 | 0.4 |
| Filler slurry | 63.7 | 63.7 | 63.7 | 63.7 | 63.7 | 63.7 |
| Biocide | 0.2 | 0.2 | 0.2 | 0.2 | 0.2 | 0.2 |
| Starch | 2 | 2 | 4 | 4 | 4 | 0 |
| Plasticizer | 1.2 | 4.3 | 2.4 | 8.55 | 2.4 | 1.2 |
| Coalescing | 0.2 | 0.2 | 0.2 | 0.2 | 0.2 | 0.2 |
| agent | | | | | | |
| Adhesion | 1 | 1 | 1 | 1 | 1 | 1 |
| promoter | | | | | | |
| Sum | 100 | 100 | 100 | 100 | 100 | 100 |

Antifoam = Foamaster NXZ/BASF; Thickener = Kelzan RD/CP KELCO; Wetting agent = BYK347/BYK; Coalescing agent = Texanol/EASTMANN; Filler Slurry (78 wt. % calcium carbonate) = Omyaflow 15-ME/OMYA; Adhesion Promoter = Silquest A1100/MOMENTIVE; Biocide = Acticide MBS/THOR; Plasticizer = Neosorb 70/02/ROQUETTE.

Biodegradability of formula 1-3 reaches 100% in 28 days with method OECD 301A done on the entire coating composition.

Biodegradability of the formula 1-3 reaches 96% in 28 days with method OECD 301F, while replacing the filler with water.

ON/OFF Shading Paints:

The raw materials described in the below table were homogenized in a suitable vessel. The agitation speed was increased to more than 800 RPM before addition of the filler and lowered to below 600 RPM when a sufficient dispersion of the powder was obtained.

The table represents different ON/OFF formulas (as concentrated solution).

| All values in wt. % | Formula 7 | Formula 8 | Formula 9 | Formula 10 |
|---|---|---|---|---|
| Water | 29.35 | 26.1 | 30.9 | 19.2 |
| Antifoam | 0.3 | 0.3 | 0.3 | 0.3 |
| Thickener | 0.05 | 0.5 | 0.1 | 0.2 |
| Wetting agent | 0.4 | 0.4 | 0.4 | 0.4 |
| Filler slurry | 63.7 | 63.7 | 63.7 | 63.7 |
| Biocide | 0.2 | 0.2 | 0.2 | 0.2 |
| Crosslinked starch | 3.5 | 6.3 | 2 | 12 |
| Plasticizer | 1.3 | 1.3 | 1.2 | 2.8 |
| Coalescing agent | 0.2 | 0.2 | 0.2 | 0.2 |
| Adhesion promoter | 1 | 1 | 1 | 1 |
| Sum | 100 | 100 | 100 | 100 |

Antifoam = Foamaster NXZ/BASF; Thickener = Kelzan RD/CP KELCO; Wetting agent = BYK347/BYK; Coalescing agent = Texanol/EASTMANN; Filler Slurry (78 wt. % calcium carbonate) = Omyaflow 15-ME/OMYA; Adhesion Promoter = Silquest A1100/MOMENTIVE; Biocide = Acticide MBS/THOR; Plasticizer = Neosorb 70/02/ROQUETTE.

As regards the used starch in the formulas 7-10:

In formula 7 and 9, varying quantities of TACKIDEX 1231 (from ROQUETTE) were used. This pregelatinized potato starch is already crosslinked by the supplier using phosphate based crosslinker. In formula 8 and 10, TACKIDEX 036SP (from ROQUETTE) is used. This pregelatinized potato starch is not crosslinked by the supplier, but was crosslinked in house using 11.4 wt. % of crosslinker relative to the weight of the starch (formula 8) or 10 wt. % of crosslinker relative to the weight of the starch (formula 10), the crosslinker being BACOTE 20 from MEL CHEMICALS.

The wear resistance of the different formulas is shown in FIG. 2, as compared to references
Eclipse F4—Self-degradable shading reference applied at 1:3 dilution
Eclipse LD²—ON/OFF shading reference applied at 1:3 dilution

All formulas 7-10 are usable as an ON/OFF shading paint. Formulas 8 and have better performance than formulas 7 and 9, due to a higher degree of crosslinking.

Based on visual inspection, all coating layers 7-9 are similar throughout the period of observation. 20 weeks (5 months) is a medium longevity for ON/OFF coating composition before being removed by a cleaning composition. Biodegradability of all coatings 7-10 was 98±2%, based on OECD 301F.

Cleaning Compositions

Different cleaning composition to remove the ON/OFF coating compositions, are described in the below table (as concentrated solutions).

Cleaner 1 is a pH neutral cleaner. The enzyme is added in the formula to degrade the starch coating layer. Other components like surfactants are added to increase cleaning performance.

Cleaner 2 is an acid cleaner where Citric Acid is used as a pH modifier. The formula acidic pH as well as the presence of the enzyme allows for degradation of the starch coating layer.

Cleaner 3 is an acid cleaner where Tartaric Acid is used as a pH modifier. No enzymes are used in this formula, but a sequestering agent is added to help the removal of the filler.

| All values in wt. % | Cleaner 1 | Cleaner 2 | Cleaner 3 |
|---|---|---|---|
| Water | 94.9 | 91.9 | 66.9 |
| Antifoam | 0.1 | 0.1 | 0.1 |
| Viscosifier | 1 | 1 | 1 |
| Surfactant | 2 | 2 | 2 |
| pH Buffer | 0 | 4 | 10 |
| Enzyme (6.25 wt % solution) | 2 | 1 | 0 |
| Sequestrant (60 wt. % solution) | 0 | 0 | 20 |
| Sum | 100 | 100 | 100 |

Antifoam = SAG 1572/VAN MEEUWEN; Thickener = Kelzan RD/CP KELCO; Surfactant = Berol 185/NOURYON; pH modifier = Citric Acid/BRENNTAG; Enzyme = Amplify Prime/NOVOZYME; Sequestrant = Gluconic Acid/ROQUETTE.

Cleaners 1 and 2 provide for optimum clearance of the coating layers 7-10, without residue. Cleaner 3 also provides some cleaning, but was found incapable of providing for full removal of the coating. Residues of resin and filler remained present at the substrate surface.

### Example 2

Two identical wooden sheds, the interior of which become generally hot in sunny summer conditions, were used as a model for an industrial building. An ON/OFF shading paint according to formula 10 was applied to the (non-transparent) roof section of one of the sheds. In sunny summer conditions, the shed with applied shading paint was noticeably cooler than the shed without shading paint. The coating composition could be removed with cleaning compositions comprising a starch-degrading enzyme.

Insights Derivable from Examples

It has been found possible to create a biodegradable coating composition which is usable for example as a shading paint on greenhouses, using crosslinked starch as a binder instead of the traditional synthetic polymer binders. Using crosslinked starch, shading performance is maintained or improved, at higher biodegradability. This provides for shading paints with less environmental impact.

1. A biodegradable coating composition, comprising a crosslinked starch and a filler, and optionally a polyol plasticizer.

2. The biodegradable coating composition according to claim 1, further comprising water and/or at least one selected from the group consisting of a dispersing agent, a wetting agent, a leveling agent, an adhesion promoter, a biocide, an antifoam agent, a coalescing agent, a thickener, a pH modifier and an antifreeze agent.

3. The biodegradable coating composition according to claim 1, wherein the crosslinked starch is pregelatinized.

4. The biodegradable coating composition according to claim 1, wherein the crosslinked starch has a ratio of crosslinking, defined as a wt. % of crosslinker relative to the weight of the starch which has been crosslinked, of 1-50%.

5. The biodegradable coating composition according to claim 1, wherein the crosslinked starch is a sodium trimetaphosphate crosslinked starch, an ammonium zirconium carbonate crosslinked starch, a copper crosslinked starch, a magnesium crosslinked starch, a borax crosslinked starch, a zirconium crosslinked starch, a titanium crosslinked starch, a calcium crosslinked starch, an aluminum crosslinked starch, a boron crosslinked starch, a chromium crosslinked starch, an iron crosslinked starch, an antimony crosslinked starch, a glyoxal crosslinked starch, a p-benzoquinone crosslinked starch, a polycarboxylate crosslinked starch, a phosphite crosslinked starch, a phosphate crosslinked starch, a silicate crosslinked starch, an epichlorohydrin crosslinked starch, a periodate crosslinked starch, a dialdehyde crosslinked starch or an anhydride crosslinked starch.

6. The biodegradable coating composition according to claim 1, wherein the polyol plasticizer is sorbitol, glycerol, ethylene glycol, polyethylene glycol, xylitol, glucose, fructose, galactose, mannitol, sucrose, maltitol, urea, or any mixture thereof.

7. The biodegradable coating composition according to claim 1, wherein the filler comprises at least one of calcium carbonate, titanium oxide, boehmite, mica, silicate, gypsum, baryte, aluminum oxide, magnesium oxide, talc, clay, an interference pigment or any combination thereof.

8. The biodegradable coating composition according to claim 1, wherein the quantity of crosslinked starch is 1-50 wt. %, and/or wherein the quantity of polyol plasticizer is 0.05-20.0 wt. % and/or wherein the quantity of filler is 1-97 wt. %, all wt. % being expressed based on the dry weight of the composition.

9. An autodegrading biodegradable coating composition according to claim 8, wherein the quantity of crosslinked starch is lower than 7 wt. %, based on the dry weight of the composition.

10. An on/off type biodegradable coating composition according to claim 8, wherein the quantity of crosslinked starch is 2-30 wt. %, based on the dry weight of the composition.

11. An outside structure at least partially provided with a biodegradable coating according to claim 1.

12. The outside structure according to claim 11, wherein said outside structure is a greenhouse or an industrial building.

13. A method for modulating the internal climate of an outside structure, comprising a) providing the exterior surface of the outside structure at least partially with an aqueous biodegradable coating composition according to claim 2, and b) drying the aqueous biodegradable coating composition to obtain a biodegradable coating layer.

14. The method according to claim 13, wherein the outside structure is provided with the aqueous biodegradable coating composition by spraying or brushing.

15. The method according to claim 13, wherein the method further comprises a step of removal of the biodegradable coating layer, which step comprises contacting the biodegradable coating layer with an aqueous cleaning composition comprising a starch degrading enzyme, and further optionally comprising a sequestrant, a surfactant and/or a pH modifier, allowing the cleaning composition to degrade the biodegradable coating layer at least partially to obtain a degraded coating layer composition, and rinsing the degraded coating layer composition.

16. The method according to claim 15, wherein the biodegradable coating layer comprises, as wt. % based on dry matter, 2-30 wt. % of crosslinked starch.

17. A method for removal of a biodegradable coating layer comprising a crosslinked starch and a filler, and optionally a polyol plasticizer, from an outside structure, comprising contacting said biodegradable coating layer on the outside structure with a cleaner comprising a starch-degrading enzyme, and rinsing the outside structure.

18. The outside structure according to claim 11, wherein the one or more transparent panels are glass panels, polycarbonate panels, polyvinylidene fluoride (PVDF) panels, polyacrylic panels, polyvinyl chloride (PVC) panels or polyethylene panels.

19. A method for preparing a biodegradable coating composition according to claim 2, comprising dispersion of the crosslinked starch and the filler, and optionally the polyol plasticizer, in water.

20. The biodegradable coating composition according to claim 1, wherein the crosslinked starch has a ratio of crosslinking, defined as a wt. % of crosslinker relative to the weight of the starch which has been crosslinked, of 5-25%.

21. The biodegradable coating composition according to claim 5, wherein the titanium crosslinked starch is a titanium lactate, titanium malate, titanium citrate, titanium ammonium lactate, polyhydroxy complexes of titanium, titanium triethanolamine, or a titanium acetyl acetonate crosslinked starch; and/or wherein the aluminum crosslinked starch is an aluminum lactate or aluminum citrate crosslinked starch; and/or wherein the polycarboxylate crosslinked starch is a citric acid, maleic acid, glutaric acid, succinic acid, phthalic acid and/or malic acid crosslinked starch; and/or wherein the silicate crosslinked starch is a tetraethyl orthosilicate (TEOS)).

22. The biodegradable coating composition according to claim 8, wherein the quantity of crosslinked starch is 1.5-30 wt. %, and/or wherein the quantity of polyol plasticizer is 0.5-15 wt. %, and/or wherein the quantity of filler is 50-95 wt. %, all wt. % being expressed based on the dry weight of the composition.

23. The biodegradable coating composition according to claim 8, wherein the quantity of crosslinked starch is 2.0-20 wt. %, and/or wherein the quantity of polyol plasticizer is 1-7 wt. %, and/or wherein the quantity of filler is 75-94 wt. %, all wt. % being expressed based on the dry weight of the composition.

24. The outside structure according to claim 11, wherein the outside structure comprises transparent panels at least partially provided with the biodegradable coating composition.

25. The method according to claim 13, wherein the outside structure is a greenhouse or an industrial building.

26. The method according to claim 13, wherein the outside structure comprises one or more transparent panels, which transparent panels have at least partially been covered with the coating composition.

27. The method according to claim 26 wherein the transparent panels have been fully covered with the coating composition.

28. The method according to claim 26, wherein the one or more transparent panels are glass panels, polycarbonate panels, polyvinylidene fluoride (PVDF) panels, polyacrylic panels, polyvinyl chloride (PVC) panels or polyethylene panels.
